(19) United States
(12) Patent Application Publication
(10) Pub. No.: US 2011/0249950 A1
(43) Pub. Date: Oct. 13, 2011

(54) QUICK RELEASE MOUNTING ASSEMBLY

(76) Inventors: ERIKA GUADALUPE CHAPA RAMIREZ, Reynosa (MX); Rolando Arturo Contreras Sanchez, Reynosa (MX); Jaime Manzo Rodriguez, Reynosa (MX); Jose Macario Mata Morales, Altamira City (MX)

(21) Appl. No.: 13/081,856

(22) Filed: Apr. 7, 2011

Related U.S. Application Data
(60) Provisional application No. 61/322,085, filed on Apr. 8, 2010.

(51) Int. Cl. G02B 6/00

(52) U.S. Cl. 385/135

(57) ABSTRACT

A mounting assembly for quickly mounting and/or removing an equipment housing from an equipment rack. The mounting assembly comprises first and second receptors secured to respective rails of the equipment rack, first and second retainers secured to the first and second receptors, respectively, and first and second housing brackets secured to opposite sides of the equipment housing. Each housing bracket has a tongue extending away from the equipment housing and each tongue slides into a slot on each of the receptors. A latch on the tongue couples the equipment housing to the mounting assembly.

### RELATED APPLICATIONS

The present application claims priority to U.S. Provisional Application No. 61/322,085 filed on Apr. 8, 2010 entitled “QUICK RELEASE MOUNTING ASSEMBLY”, the contents of which are incorporated by reference.

### BACKGROUND

The present disclosure generally relates to mounting assemblies and more specifically to quick release mounting assemblies for coupling a fiber optic equipment housing to an equipment rack.

Mounting assemblies and related fastener hardware are widely used to mount and secure components, such as equipment housings, to equipment racks. Such mounting apparatus commonly employ mounting assembly hardware that is affixed to or integral with the equipment rack and a plurality of fasteners (often four or more) that pass through the mounting assembly and are driven, screwed, or otherwise attached to the equipment housing and secured to the equipment rack. It is common, for example, that equipment housings are provided with rack ears or flanges that are fastened to spaced rails of an equipment rack with rack screws to mount and secure the equipment housing within the rack.

However, a significant disadvantage of such mounting assemblies is that during installation, an installer is required to position and hold the equipment housing accurately in place with one hand, while simultaneously, with the other hand, operate an installation tool, such as a screw driver or wrench. Furthermore, because of the size and weight of the of the equipment housings, more than one installer can be required to either install or remove the equipment housing from the equipment rack. There is a need for an improved apparatus and method of mounting equipment housings in an equipment rack.

### SUMMARY

Briefly described, one embodiment of a mounting assembly for mounting an equipment housing to spaced rails of an equipment rack comprises a first receptor adapted to be secured to one rail of the rack and a second receptor adapted to be secured to the other rail of the rack opposite the first receptor. The first and second receptors each define a slot extending away from the rail to an open end.

A first housing bracket is adapted to be secured to a side of the equipment housing and defines a first tongue that projects away from the housing. A second housing bracket is adapted to be secured to an opposite side of the equipment housing and defines a second tongue that projects away from the housing. The first and second tongues are sized to slide into the first and second slots, respectively, of the receptors.

The mounting assembly further comprises a first retainer on the first receptor and a second retainer on the second receptor. The first and second retainers are configured to interact with the first and second tongues respectively when the tongues slide into respective slots of the receptors to secure the tongues in place within the slots.

A first latch is arranged on the first tongue and a second latch is arranged on the second tongue. The first and second retainers interact with the first and second latches when the tongues slide into the respective slots of the receptors. Each of the latches comprises a spring pin. The spring pin has a retracted position and an extended position and is spring biased to its extended position. Each of the retainers is formed with a hole sized to receive the spring pin of a respective tongue when the tongue is slid into its respective slot.

In another embodiment, an equipment rack comprises a pair of spaced apart rails and the rails have a series of openings for the mounting of equipment. A first receptor is mounted to one rail and a second receptor is mounted to the other rail opposite the first receptor. An equipment housing having opposed sides is disposed substantially between the spaced apart rails. A first bracket is mounted to a side of the equipment housing and comprises a projection releasably coupled with the first receptor and a second bracket is mounted to the opposite side of the equipment housing and comprises a projection releasably coupled with the second receptor.

Additional features and advantages will be set forth in the detailed description which follows, and in part will be readily apparent to those skilled in the art from that description or recognized by practicing the embodiments as described herein, including in the detailed description which follows, the claims, as well as the appended drawings.

It is to be understood that both the foregoing summary and the following detailed description are merely exemplary of preferred embodiments, and are intended to provide an overview or framework to understanding the nature and character of the claims. The accompanying drawings are included to provide a further understanding, and are incorporated in and constitute a part of this specification. The drawings illustrate the exemplary embodiments, and together with the description serve to explain principles and operation of the various embodiments.

### BRIEF DESCRIPTION OF THE DRAWINGS

The components of the following figures are illustrated to emphasize the general principles of the present disclosure and are not necessarily drawn to scale. Reference characters designating corresponding components are repeated as necessary throughout the figures for the sake of consistency and clarity.

FIG. 1 is an isometric view showing a mounting assembly in a uncoupled configuration according to a first embodiment.

FIG. 2 is an isometric view showing a housing bracket of the first embodiment.

FIG. 3 is an isometric view showing a mounting assembly in a coupled configuration according to a second embodiment.

FIG. 4 is an isometric view of an equipment housing mounted to an equipment rack by way of the mounting assembly of FIG. 1.

### DETAILED DESCRIPTION

The present disclosure is directed to a mounting assembly that allows for rapid coupling mounting and demounting of an equipment housing in or from an equipment rack. Although disclosed primarily within the context of a mounting assembly for a housing that houses optical components or electronic equipment, the skilled artisan will recognize that the principles of the present disclosure are not limited to a mounting assembly for use with such equipment but extend to any type of housing that may be required to be coupled or uncoupled from a rack.

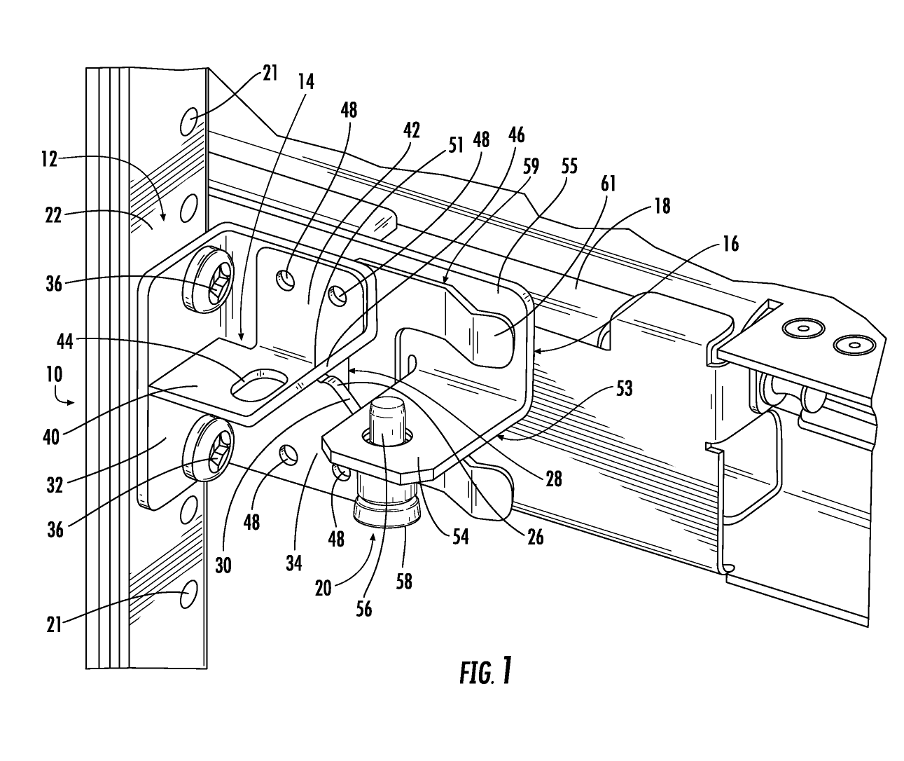

FIG. 1 in an isometric view showing a mounting assembly 10 in an uncoupled configuration according to a first embodiment of the disclosure. The mounting assembly may be used for mounting an equipment housing 18 to spaced rails 22 of an equipment rack. The mounting assembly 10 may transition between an uncoupled configuration as illustrated and a coupled configuration (FIG. 3). Generally, the mounting assembly 10 comprises a first receptor 12, a first retainer 14 and a first housing bracket 16. The first receptor 10 is mounted or secured to a rail 22 of the equipment rack and the first housing bracket 16 is secured to a side of the equipment housing 18.

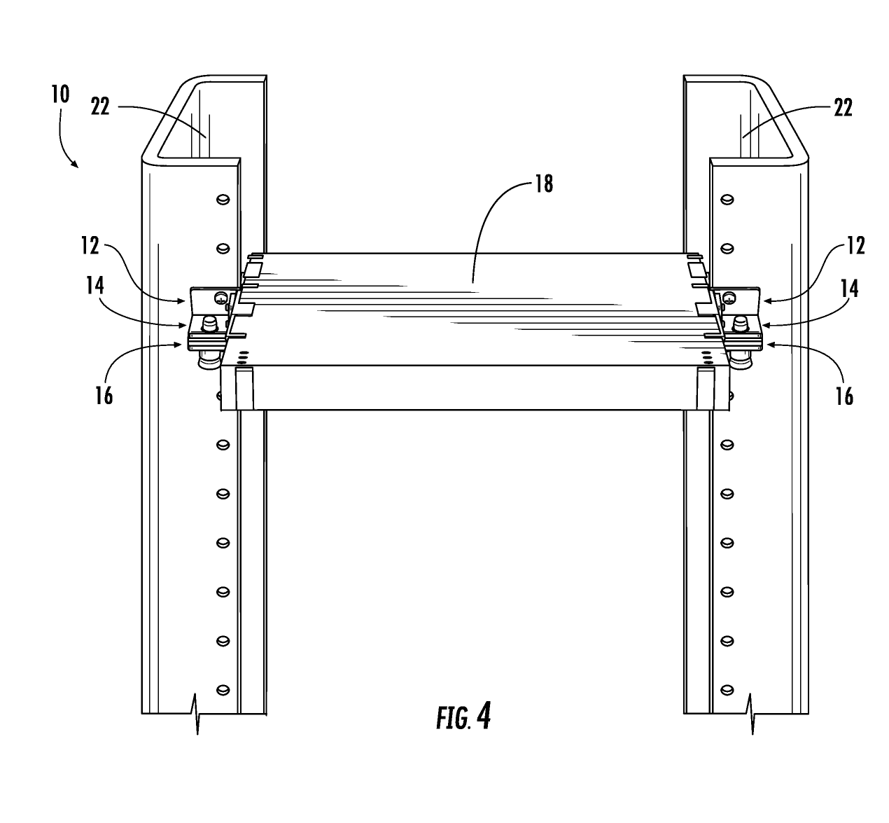

The mounting assembly 10 further comprises a second receptor, a second retainer and a second housing bracket. The second receptor, the second retainer and the second housing bracket (FIG. 4) are not illustrated but are generally the same in form, fit and function as the first receptor 12, the first retainer 14 and the first housing bracket 16, respectively, albeit a mirror image thereof. The second retainer is mounted to an opposite rail of the rack and the second housing bracket is mounted to an opposite side of the equipment rack. The discussion contained herein regarding the first receptor 12, the first retainer 14 and the first housing bracket 16 is applicable to the second receptor, the second retainer and the second housing bracket, respectively.

As mentioned, second receptor is secured to a rail spaced from rail 22 of the equipment rack and is opposite the first receptor 12. The second housing bracket is adapted to be secured to an opposite side of the equipment housing.

The first receptor 12 is generally “L” shaped and comprises a first leg 32 and a second leg 34. The first leg 32 is secured to the rail 22 by a mechanical fastener 36, such as, for example, a rack screw, a bolt, a pin, a rivet, a threaded connector, or combinations thereof. The mechanical fasteners 36 pass through openings or holes in the first leg 32 and are fastened through openings 21, which may be threaded, to the rail 22. The second leg 34 extends from the first leg 32 at a predetermined angle, which is illustrated as approximately a right angle. The predetermined angle need not be approximately a right angle and may be any angle that facilitates transition of the mounting assembly 10 between the coupled and uncoupled configurations and/or mounting of the equipment housing 18 to the equipment rack.

The second leg 34 generally extends away from the rail 22 and comprises a slot 26 having an open end 28. The slot 26 extends away from the rail 22, toward the open end 28. The slot 26 has a flared portion 30 proximate the open end 28. The flared portion 30 flares outward from the slot 26 toward the open end 28. The flared portion 30 results in the open end 28 being wider than the slot 26 and facilitates alignment of a tongue 54 to be received by the slot 26. The flared portion 30 may be a chamfer or a bevel or any suitable geometry that widens the open end 28 of the slot 26 or otherwise directs the tongue 54 into the slot 26. Furthermore, the flared portion 30 may have a round 31′ (FIG. 3) at an outermost portion to facilitate further the alignment of the tongue 54 relative to the slot 26.

The first retainer 14 comprises a retainer base 40, which extends from a retainer mount 42. In some embodiments, the retainer base 40 may extend directly from the second leg 34 of the first receptor 12 and away from the equipment housing 18. As illustrated, the retainer mount 42 is affixed to the second leg 34 of the first receptor 12 by a mechanical fastener 48, which secures the first retainer 14 to the first receptor 12. The first retainer 14 is secured to the first receptor 12 such that the base 40 is located adjacent one side of the slot 26. A passage or hole 44 is formed in the retainer base 40.

The first retainer 14 further comprises a strike plate 46. The strike plate 46 comprises an angled surface 51 that is oriented and configured to be engaged by a spring pin 56 of the first housing bracket 16. In the present embodiment, the angled surface 51 of the strike plate 46 is at an angle 47′ (FIG. 3) that approximately corresponds to an angle of the flared portion 30. In other embodiments, the angled surface 51 of the strike plate 46 may at any angle 47′ and it is not necessary that the angle 47′ of the strike plate 46 correspond to the angle of the flared portion 30.

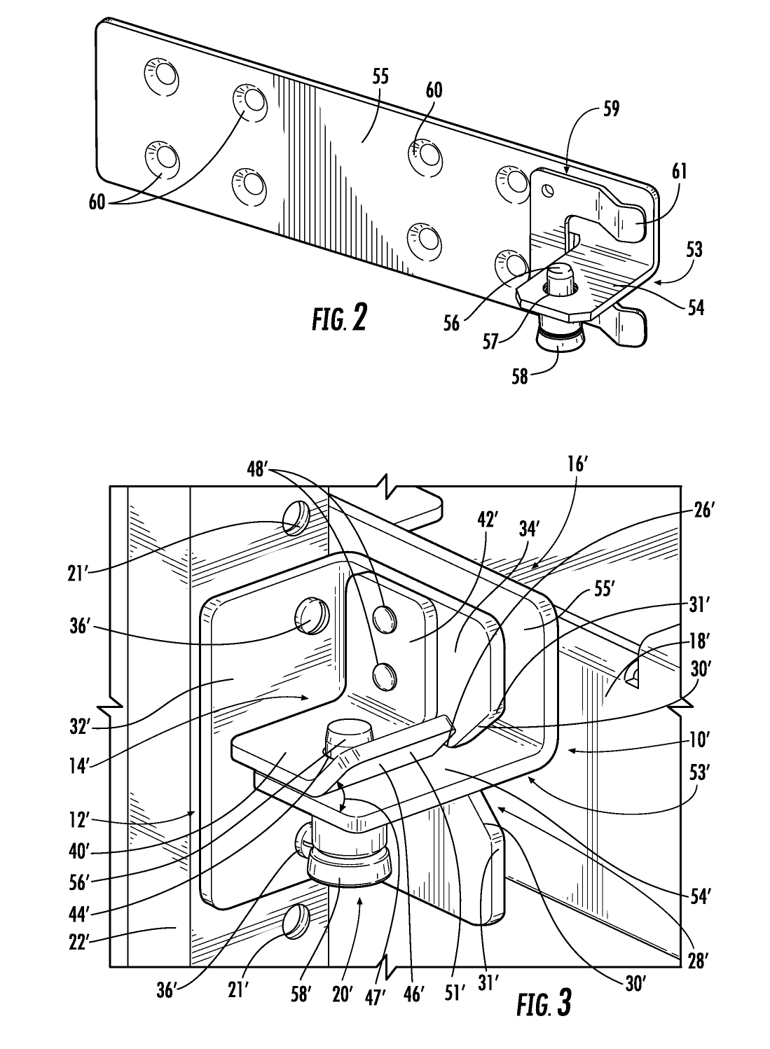

With reference to FIGS. 1 and 2, the first housing bracket 16 comprises a plate 55, which is secured to a side of the equipment housing 18. An appropriate number of mechanical fasteners may be used to secure the first housing bracket 16 to the equipment housing 18. Each mechanical fastener is inserted through a respective opening 60 (a representative number of openings 60 are identified) and into the equipment housing 18. The appropriate number of mechanical fasteners needed may depend on factors such as the size and weight of the equipment housing 18 and/or an amount of space available for placement of the mechanical fasteners.

The first housing bracket 16 further comprises an alignment feature 59 that is located proximate the tongue 54. The alignment feature 59 may be secured to the plate 55 by a mechanical fastener, or fabricated as part of the plate 55. The alignment feature 59 comprises a spacer 61 that extends away from the plate 55 toward the tongue 54. The spacer 61 functions to locate the equipment housing 18 approximately evenly between the spaced rails 22.

A projection 53 comprising the tongue 54 extends from the plate 55 and away from the equipment housing 18. The tongue 54 is sized and configured to slide into the slot 26 of the first receptor 12. The first retainer 14 interacts with the tongue 54 when the tongue 54 slides into the slot 26 and secures the tongue 54 in place within the slot 26. The tongue 54 extends generally horizontally when disposed within the slot 26.

The first housing bracket 16 further comprises a latch 20 arranged on the tongue 54. The latch 26 may be a self clutching fastener. The latch 20 may be used to lock the tongue 54 releasably in place within the slot 26. The latch 20 comprises a latch handle 58 and a spring pin 56, which extends through a hole 57 in the tongue 54. The spring pin 56 has a retracted position and an extended position and is biased to its extended position. The hole 44 in the retainer base 40 is sized to receive the spring pin 56 of the tongue 54 when the tongue 54 is slid into the slot 26. The strike plate 46 engages the spring pin 56 as the tongue 54 slides into the slot 26 causing the spring pin 56 to move to its retracted position. Further movement of the tongue 54 into the slot 26 such that the spring pin 56 aligns with the hole 44 in the retainer base 40 will allow the spring pin 56 to move or spring to its extended position within the hole 44 releasably locking the housing bracket 16 to the receptor 12.

FIG. 3 is an isometric view showing a mounting assembly 10′ in a coupled configuration. The mounting assembly 10′ is comprised of a generally “L” shaped first receptor 12′, a first retainer 14′ and a first housing bracket 16′ coupled to the first receptor 12′. The first receptor 12′ is secured to a rail 22′ of an equipment rack by a mechanical fastener 36′. The rail 22′ comprises openings 21′ to receive a portion of the mechanical fastener 36′ and secure the mounting assembly 10′ to the equipment rack. The fasteners may be rack screws and the openings may be threaded holes.

The first receptor 12′ comprises a first leg 32′ and a second leg 34′ that extends from the first leg 32′ and away from a rail 22′. The second leg 34′ extends from the first leg 32′ at a predetermined angle that is approximately a right angle.

The second leg 34′ generally extends away from the rail 22′ and comprises a slot 26′ having an open end 28′. The slot 26′ extends away from the rail 22′, toward the open end 28′. The slot 26′ has a flared portion 30′ proximate the open end 28′. The flared portion 30′ flares outward from the slot 26′ toward the open end 28′. The flared portion 30′ results in the open end 28′ being wider than the slot 26′ and facilitates alignment of a tongue 54′ that is received by the slot 26′. The flared portion 30′ may have a round 31′at an outermost portion to further facilitate alignment of the tongue 54′ relative to the slot 26′.

The first retainer 14′ comprises a retainer base 40′ which extends from a retainer mount 42′. In some embodiments, the retainer base 40′ may extend directly from the second leg 34′ of the first receptor 12′ and away from the equipment housing 18′. As illustrated, the retainer mount 42′ is affixed to the second leg 34′ of the first receptor 12′ by a mechanical fastener 48′, which secures the first retainer 14′ to the first receptor 12′. The first retainer 14′ is secured to the first receptor 12′ so that its base extends adjacent one side of the slot 26′. A passage or hole 44′ is formed in the retainer base 40′. The first retainer 14′ further comprises a strike plate 46′. The strike plate 46′ comprises an angled surface 51′ that is oriented and configured to be engaged by a spring pin 56′ of the first housing bracket 16′.

The first housing bracket 16′ comprises a plate 55′, which is secured to a side of the equipment housing 18′. An appropriate number of mechanical fasteners may be used to secure the first housing bracket 16′ to the equipment housing 18′. The appropriate number of mechanical fasteners needed may depend on factors such as the size and weight of the equipment housing 18′ and/or an amount of space available for placement of the mechanical fasteners.

A projection 53′ comprising the tongue 54′ extends from the plate 55′ and away from the equipment housing 18′. The tongue 54′ is sized and configured to slide into the slot 26′ of the first receptor 12′. The first retainer 14′ interacts with the tongue 54′ when the tongue 54′ slides into the slot 26′ and secures the tongue 54′ in place within the slot 26′. The tongue 54′ extends generally horizontally when disposed within the slot 26′.

The first housing bracket 16′ further comprises a latch 20′ arranged on the tongue 54′. The latch 20′ comprises a latch handle 58′ and a spring pin 56′, which extends through a hole in the tongue 54′. The spring pin 56′ has a retracted position and an extended position. The spring pin 56′ is spring biased to its extended position and extends through the hole 44′ in the retainer base 40′. The hole 44′ in the retainer base 40′ is sized to receive the spring pin 56′ of the tongue 54′ when the tongue 54′ is slid into the slot 26′. The strike plate 46′ engages the spring pin 56′ as the tongue 54′ slides into the slot 26′ to move the spring pin to its retracted position. Further movement of the tongue 54′ into the slot 26′ such that the spring pin 56′ aligns with the hole 44′ in the retainer base 40′ allows the spring pin 56′ to move or sping to its extended position within the hole 44′ to couple and lock the housing bracket 16′ to the receptor 12′. As illustrated, the spring pin 56′ is in the extended position with the first housing bracket 16′ coupled to the first receptor 12′. An upper surface of the tongue 54′ contacts or is closely adjacent a lower surface of the retainer base 40′ and the lower surface of the tongue 54′ rests on the lower surface of the slot 26′. This helps to support the weight of the equipment housing 18′ and stabilize the equipment housing 18′ within the rack.

With reference to FIG. 1, to transition the mounting assembly 10 from the uncoupled position to the coupled position, an installer first slides the equipment housing in the rack between its rails and brings the tongues of the housing brackets mounted to the equipment housing proximate the first receptor and the second receptors on opposite sides of the rack. The equipment housing has the first housing bracket and the second housing bracket secured to opposite sides of the equipment housing. The installer then brings the tongues of the housing brackets proximate the open ends of the slots of the first and second receptors and presses the equipment housing toward the rack to move the tongues into the slots. The flared portions of the open ends help guide the tongues initially into their respective slots. As the tongues are moved within their respective slots, the spring pins engage with respective strike plates and are depressed thereby from their extended position to their retracted position against the bias of their springs. When the spring pins align with respective holes of their respective retainers, the spring pins spring back to their extended positions coupling and locking the housing brackets to their respective receptors.

To uncouple the equipment housing from the mounting assembly for removing it from the rack, the installer pulls the handles of the latches to move the spring pins from their extended position to their retracted position and out of the holes of the receptors. The installer then pulls the housing away from the equipment rack and the tongues slide out of the slots of the receptors to allow the housing to be removed from the rack. When the installer releases the handles of the latches, the spring pins return to their extended position. The mounting assembly thus functions as a quick release mounting assembly, which transitions from the coupled or locked configuration to the uncoupled configuration rapidly while eliminating the need for the installer to balance or support the equipment housing while manipulating an installation tool, such as a screwdriver or wrench.

FIG. 4 is an isometric view of an equipment housing 18 mounted to a pair of rails 22 of an equipment rack by way of a mounting assembly 10. The mounting assembly 10 includes a first receptor 12, a first retainer 14, and a first housing bracket 16. The mounting assembly 10 also includes a second receptor 112, a second retainer 114 and a second housing bracket 116.

The embodiments of FIGS. 1 and 3 require both first and second receptors, first and second retainers and first and second housing brackets, for a complete mounting assembly. Although FIGS. 1 and 3 illustrate a first receptor, a first retainer and a first housing bracket, the skilled artisan will recognize that a second receptor, a second retainer and a second housing bracket are substantially the same as the first receptor, the first retainer and the first housing, but mounted such that they essentially mirror each other on the opposite side of the rack. Further, it is within the scope of the invention that only one receptor and housing bracket be used on one side of the rack with the other side of the equipment housing being fastened to the opposite rack rail in a traditional manner, such as with screws. Such an arrangement simplifies somewhat the mounting of an equipment housing in the rack.

The mounting assembly may be fabricated or manufactured from any suitable material using any suitable manufacturing process. Acceptable materials may include, but not be limited to, steels, steel alloys and aluminum alloys. Furthermore, the first receptor and first retainer are disclosed as separate components mechanically attached. There is no requirement that the first receptor and first retainer be manufactured or produced as separate components and they may be cast as a single component if so desired.

The term mechanical fastener used throughout this disclosure is also understood to mean welding, bonding, brazing and the like. The term latch used throughout this document is not intended to be limited to spring loaded pin latches but may be any means of latching or coupling one element to another such as the use of pins, screws, threaded fasteners, rivets and the like.

It will be apparent to those skilled in the art that various modifications and variations can be made without departing from the spirit or scope of the present disclosure.

We claim:

1. A mounting assembly for mounting an equipment housing to spaced rails of an equipment rack, the mounting assembly comprising:
a first receptor adapted to be secured to one rail of the rack and defining a first slot extending away from the rail to an open end;
a second receptor adapted to be secured to the other rail of the rack opposite the first receptor and defining a second slot extending away from the rail to an open end;
a first housing bracket adapted to be secured to a side of the equipment housing and defining a first tongue projecting away from the housing, the first tongue being sized to slide into the first slot;
a second housing bracket adapted to be secured to an opposite side of the equipment housing and defining a second tongue projecting away from the housing, the second tongue being sized to slide into the second slot.

2. The mounting assembly of claim 1 and further comprising a first retainer on the first receptor and a second retainer on the second receptor, the first and second retainers being configured to interact with the first and second tongues respectively when the tongues slide into respective slots of the receptors to secure the tongues in place within the slots.

3. The mounting assembly of claim 2 and further comprising a first latch on the first tongue and a second latch on the second tongue, the first and second retainers interacting with the first and second latches when the tongues slide into the respective slots of the receptors.

4. The mounting assembly of claim 3 and wherein each of the latches comprises a spring pin having a retracted position and an extended position and being spring biased to its extended position and wherein each of the retainers is formed with a hole sized to receive the spring pin of a respective tongue when the tongue is slid into its respective slot.

5. The mounting assembly of claim 3 and further comprising a strike plate on each of the retainers configured and oriented to be engaged by the spring pin as a corresponding tongue slides into the slot to move the spring pin to its retracted position, further movement of the tongue into the slot aligning the spring pin with the hole in the retainer allowing the spring pin to move to its extended position within the hole.

6. The mounting assembly of claim 5 and wherein the strike plate comprises an angled surface.

7. The mounting assembly of claim 2 and wherein each retainer is secured to its respective receptor adjacent one side of the open ended slot.

8. The mounting assembly of claim 2 and wherein the tongues extend generally horizontally when disposed in their respective slots.

9. The mounting assembly of claim 1 and wherein the open ends of the first and second slots are flared.

10. The mounting assembly of claim 1 and wherein each of the first and second receptors is generally L-shaped with one leg bearing holes through which rack screws may be inserted to secure the receptor to a rail of the rack, the open ended slot being formed in the other leg.

11. The mounting assembly of claim 1 and wherein each of the housing brackets comprises a plate configured to be mounted to a side of the housing and wherein the tongue projects from the plate.

12. The mounting assembly of claim 1 and further comprising a latch on at least one of the first and second tongues, the latch being configured to interact with the corresponding receptor to lock the tongue releasably within its corresponding slot.

13. The mounting assembly of claim 12 and wherein the latch comprises a spring pin.

14. The mounting assembly of claim 13 and wherein the corresponding receptor further comprises a retainer having an opening through which the spring pin extends when the tongue slides into the slot.

15. The mounting assembly of claim 14 and wherein the receptor further comprises a strike plate positioned to depress the spring pin as the tongue slides into the slot, the spring pin springing into the opening upon further movement of the tongue into the slot.

16. The mounting assembly of claim 1, wherein the housing houses optical components.

17. An equipment rack comprising:
a pair of spaced apart rails having a series of openings for the mounting of equipment;
a first receptor mounted to one rail;
a second receptor mounted to the other rail opposite the first receptor;
an equipment housing having opposed sides and being disposed substantially between the spaced apart rails;
a first bracket mounted to a side of the equipment housing and comprising a projection releasably coupled with the first receptor; and
a second bracket mounted to the opposite side of the equipment housing and comprising a projection releasably coupled with the second receptor.

18. The equipment rack of claim 17 and wherein the first and second receptors comprise legs extending away from the respective rails.

19. The equipment rack of claim 18 and wherein the projections of the brackets comprise tongues extending away from the sides of the equipment housing, the tongues being coupled with the legs of the receptors.

20. The equipment rack of claim 19 and wherein the legs comprise slots and wherein the tongues of the brackets are disposed within the slots of the legs.

21. The equipment rack of claim 20 and further comprising a latching mechanism for releasably locking the tongues in place within the slots.

22. The equipment rack of claim 21 and wherein the latching mechanism comprises a pin on at least one of the tongues and a hole formed in the corresponding one of the receptors, the pin being disposed in the hole.

23. The equipment rack of claim 22 and wherein the receptor further comprises a retainer projecting from the receptor on one side of the slot, the hole being formed in the retainer.

24. The equipment rack of claim 23 and wherein the retainer comprises a strike plate and wherein the pin is a spring pin, the spring pin engaging the strike plate to depress the pin as the tongue slides into the slot, the pin springing into the hole when the tongue is fully disposed in the slot.

25. The equipment rack of claim 17, wherein the housing houses optical components.

26. A mounting assembly comprising:
a receptor having a first leg configured to be mounted to a rack rail and a second leg projecting at a predetermined angle with respect to the first leg, the second leg defining an elongated slot;
a bracket comprising a plate configured to be mounted to a side of an equipment housing and a tongue projecting at a predetermined angle with respect to the plate;
the tongue configured to be received in the slot for mounting the equipment housing adjacent the rack rail.

27. The mounting assembly of claim 26 and further comprising a second like receptor configured to be mounted to a second rack rail spaced from the first rack rail in an equipment rack and a second like bracket configured to be mounted to an opposite side of the equipment housing, the tongues of the brackets configured to be received in the slots of the receptors for mounting the equipment housing between the rack rails.

28. The mounting assembly of claim 27 and further comprising a latch on at least one of the tongues configured to couple with a hole in a corresponding receptor to lock the tongue releasably in the slot of the receptor.

29. The mounting assembly of claim 28 and wherein the latch comprises a spring pin.
